(19) United States
(12) Patent Application Publication
(10) Pub. No.: US 2016/0315414 A1
(43) Pub. Date: Oct. 27, 2016

(54) CONNECTOR HOUSING ASSEMBLY FOR SEALING TO A CABLE

(71) Applicant: TYCO ELECTRONICS CORPORATION, Berwyn, PA (US)

(72) Inventors: George Richard Defibaugh, Aiken, SC (US); Robert Lynn Bendorf, Millerstown, PA (US); Maurizio Mercurio, Harrisburg, PA (US); Ricardo Lee Koller, Lititz, PA (US); Fieldon Nathan Daubert, Annville, PA (US)

(21) Appl. No.: 15/072,668

(22) Filed: Mar. 17, 2016

Related U.S. Application Data
(60) Provisional application No. 62/153,261, filed on Apr. 27, 2015.

(51) Int. Cl. H01R 13/52; H01R 13/58

(52) U.S. Cl. CPC H01R 13/5205; H01R 13/582

(57) ABSTRACT

A connector module includes a housing assembly defined by an upper shell and a lower shell that mate and define an interior chamber therebetween. A cable segment of the upper shell includes an upper sealing rib extending into the interior chamber from an inner surface of the upper shell, and the cable segment of the lower shell includes a lower sealing rib extending into the interior chamber from an inner surface of the lower shell. The upper and lower sealing ribs rib each including two blades and a slot defined between the two blades configured to receive a cable therein. When the upper and lower shells are mated, a front side of the upper sealing rib abuts a rear side of the lower sealing rib to seal the interior chamber between the cable in the slots and the inner surfaces of the upper and lower shells.

### CROSS-REFERENCE TO RELATED APPLICATIONS

This application claims priority to U.S. Provisional Application No. 62/153,261, filed 27 Apr. 2015, which is incorporated by reference in its entirety.

### BACKGROUND OF THE INVENTION

The subject matter herein relates generally to housing assemblies of connectors, and more specifically to connector housing assemblies that seal to cables extending from the housing assemblies.

Various types of connectors, including electrical connectors and optical connectors, include cables that extend from housings. The housing typically covers and protects electrical and/or optical components disposed within the housing. The housing is also configured to provide an interface for mating with a mating connector, which allows the electrical and/or optical components within the housing to connect, electrically and/or optically, to corresponding components of the mating connector. The cable terminates to the electrical and/or optical components within the housing, and the cable extends from the housing such that an opposite end of the cable connects to an electrical or optical device, such as a computer, a printed circuit board, an electrical power outlet, or the like.

The connector may be exposed to various debris and contaminants, such as dirt, dust, water, oil, sand, chemicals, and the like. Such debris and contaminants may damage or at least interfere with the operations of the electrical and/or optical components within the housing if able to enter the housing. A cable end of the housing is the portion of the housing that receives the internal segment of the cable, and is the portion of the housing from which the external segment of the cable extends. The cable end is one potential ingress location for debris and contaminants to enter the housing. To seal the cable end of the housing around the cable, some connectors use additional sealing components, such as rubber bushings or gaskets, that are placed between the cable and an interior surface of the housing that defines an opening for receiving the cable in order to seal the opening. However, the additional sealing components may increase costs due to the cost of the sealing components and the cost of additional assembly steps. Plus, the additional sealing components, such as rubber bushing or gaskets, may lose effectiveness over time, due to hardening of the material, for example, which may result in leak paths that allow debris and contaminants into the housing beyond the sealing components.

A need remains for a connector housing that provides an effective seal around a cable to prevent debris and contaminants from entering the cable end of the housing without using costly additional sealing components.

### BRIEF DESCRIPTION OF THE INVENTION

In one embodiment, a connector module is provided that includes a housing assembly. The housing assembly is defined by an upper shell and a lower shell that mate at an interface and define an interior chamber therebetween. The upper shell and the lower shell each includes a respective cable segment that together define a cable securing region extending along a longitudinal axis. The cable segment of the upper shell includes an upper sealing rib extending into the interior chamber from an inner surface of the upper shell. The cable segment of the lower shell includes a lower sealing rib extending into the interior chamber from an inner surface of the lower shell. The upper sealing rib and the lower sealing rib each includes two blades and a slot defined between the two blades. The slots of the upper sealing rib and the lower sealing rib are configured to receive a common cable therein. When the upper shell and the lower shell are mated, a front side of the upper sealing rib abuts a rear side of the lower sealing rib to seal the interior chamber around the cable in the slots of the upper and lower sealing ribs.

In another embodiment, a connector module is provided that includes a housing assembly. The housing assembly is defined by an upper shell and a lower shell that mate at an interface and define an interior chamber therebetween. The upper shell and the lower shell each includes a respective cable segment that together define a cable securing region extending along a longitudinal axis. The cable segment of the upper shell includes at least first and second upper sealing ribs extending into the interior chamber from an inner surface of the upper shell. The second upper sealing rib is spaced apart from the first upper sealing rib along the longitudinal axis and defines an upper gap therebetween. The cable segment of the lower shell includes at least a first lower sealing rib extending into the interior chamber from an inner surface of the lower shell. The first and second upper sealing ribs and the first lower sealing rib each includes two blades and a slot defined between the two blades that is configured to receive a cable therein. When the upper shell and the lower shell are mated, the first lower sealing rib is received in the upper gap. The upper gap has an axial length along the longitudinal axis that is no greater than a thickness of the first lower sealing rib along the longitudinal axis such that a front side of the first lower sealing rib abuts a rear side of the first upper sealing rib and a rear side of the first lower sealing rib abuts a front side of the second upper sealing rib to seal the interior chamber around the cable in the slots of the upper and lower sealing ribs.

### BRIEF DESCRIPTION OF THE DRAWINGS

FIG. 1 is a perspective view of a connector in accordance with an embodiment.

FIG. 2 is an exploded perspective view of the connector module of the connector shown in FIG. 1 according to an exemplary embodiment.

FIG. 3 is a sectional exploded view of the housing assembly according to an embodiment.

FIG. 4 is a sectional assembled view of the housing assembly according to an embodiment.

FIG. 5 is an exploded side view of a portion of the housing assembly according to an embodiment.

FIG. 6 is a perspective cross-sectional view of the connector module according to an embodiment, showing the cable in an assembled housing assembly.

FIG. 7 is a perspective view of the lower shell according to an embodiment.

### DETAILED DESCRIPTION OF THE INVENTION

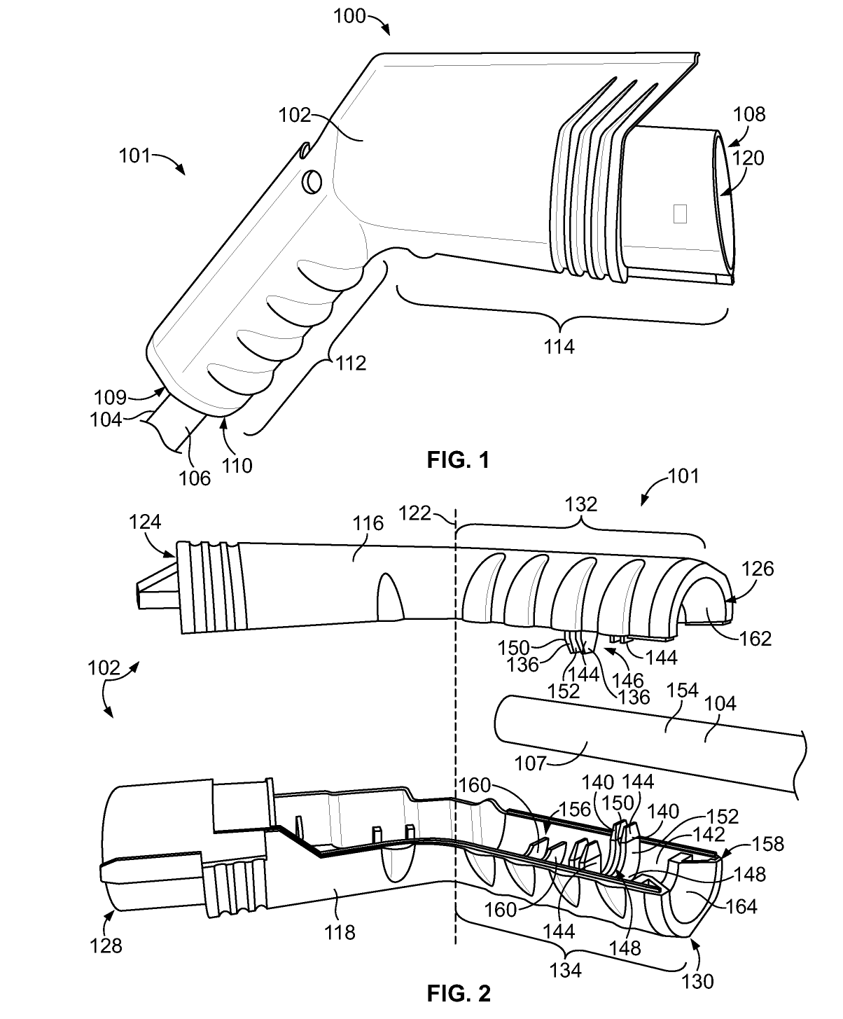

FIG. 1 is a perspective view of a connector 100 in accordance with an embodiment. The connector 100 is configured to mate with a mating connector (not shown) to provide a continuous signal path through the connector 100 and the mating connector. The connector 100 may be a plug that is configured to be received into a receptacle of the mating connector, or, alternatively, the connector 100 may define a receptacle that is configured to receive a plug portion of the mating connector. The connector 100 may be an electrical connector configured to convey electrical signals (such as data and/or power) to and from the mating connector, and/or the connector 100 may be an optical connector configured to convey optical signals (such as visible light and/or infrared light) to and from the mating connector.

The connector 100 includes a connector module 101 and an electrical and/or optical component (not shown) housed within the connector module 101. The connector module 101 includes a housing assembly 102 and a cable 104. An interior portion 107 (shown in FIG. 2) of the cable 104 is held within the housing assembly 102. An exterior portion 106 of the cable 104 extends from the housing assembly 102. The housing assembly 102 in the embodiments described herein is configured to seal the cable 104 to the housing assembly 102 to prevent debris and other contaminants from entering the housing assembly 102 around the cable 104. The housing assembly 102 holds the electrical and/or optical component therein. The component may be electrical, such as a printed circuit board or card, electrically conductive contacts, or the like. Alternatively, the component may be optical, such as a lens, an optical lightguide, an optical stub, or the like. The housing assembly 102 also may include both at least one electrical component and at least one optical component.

The housing assembly 102 extends between a mating end 108 and a cable end 110. The mating end 108 interfaces with the mating connector. The cable end 110 receives the cable 104 through a cable opening 109, such that the exterior portion 106 of the cable 104 extends from the cable end 110. In the illustrated embodiment, the housing assembly 102 is not linear between the mating end 108 and the cable end 110. For example, the housing assembly 102 has a cable securing region 112 that includes the cable end 110 and a mating region 114 that includes the mating end 108. The cable securing region 112 extends generally from the cable end 110 to the mating region 114, and the mating region 114 extends generally from the mating end 108 to the cable securing region 112. The cable securing region 112 is oriented transverse to the mating region 114 in the illustrated embodiment, such that an axis defined longitudinally through the cable securing region 112 would extend across an axis defined longitudinally through the mating region 114 at an angle other than a right angle. In an alternative embodiment, however, the cable securing region 112 may be oriented perpendicular to the mating region 114, such that the housing assembly 102 has a right angle shape. In another alternative embodiment, the housing assembly 102 may be linear, such that the cable securing region 112 extends parallel to or in-line with the mating region 114.

The housing assembly 102 defines an interior chamber 120 that extends through the housing assembly 102 between the mating end 108 and the cable end 110. The electrical and/or optical component is held within the interior chamber 120. A distal end (not shown) of the cable 104 terminates to the electrical and/or optical component within the housing assembly 102 to transmit electrical and/or optical signals to and/or from the component. For example, the cable 104 may include one or more electrical conductors (not shown) that mechanically engage and electrically connect to contact pads or conductive vias of a printed circuit board that defines the electrical and/or optical component.

The housing assembly 102 of the connector module 101 may have a shape that corresponds to a particular selected electrical and/or optical application. In the illustrated embodiment, the connector module 101 is configured as an electrical charger for an electric vehicle. Thus, the mating end 108 may be configured to be plugged into a receptacle located on an electric vehicle, and the cable 104 may be used to convey electrical power (for example, current and voltage) between the electric vehicle and a power source to charge the batteries on the electric vehicle. An electric vehicle charger is merely one example embodiment, and the housing assembly 102 may be shaped for other electrical and optical applications in other embodiments.

In the embodiments described herein, the housing assembly 102 is configured to provide a seal around the cable 104 that prevents the permeation of debris and other contaminants, such as dirt, dust, sand, water, oil, chemicals, and the like, into the housing assembly 102 through the cable end 110. The seal may be provided by features in the housing assembly that are formed integral to the housing assembly 102, such that additional discrete sealing components, such as bushings, gaskets, and the like, are not necessary to seal the cable end 110. The housing assembly 102 may also include other integral features that may be configured to support retention of the cable 104 within the housing assembly 102 and/or to provide strain relief at the cable end 110.

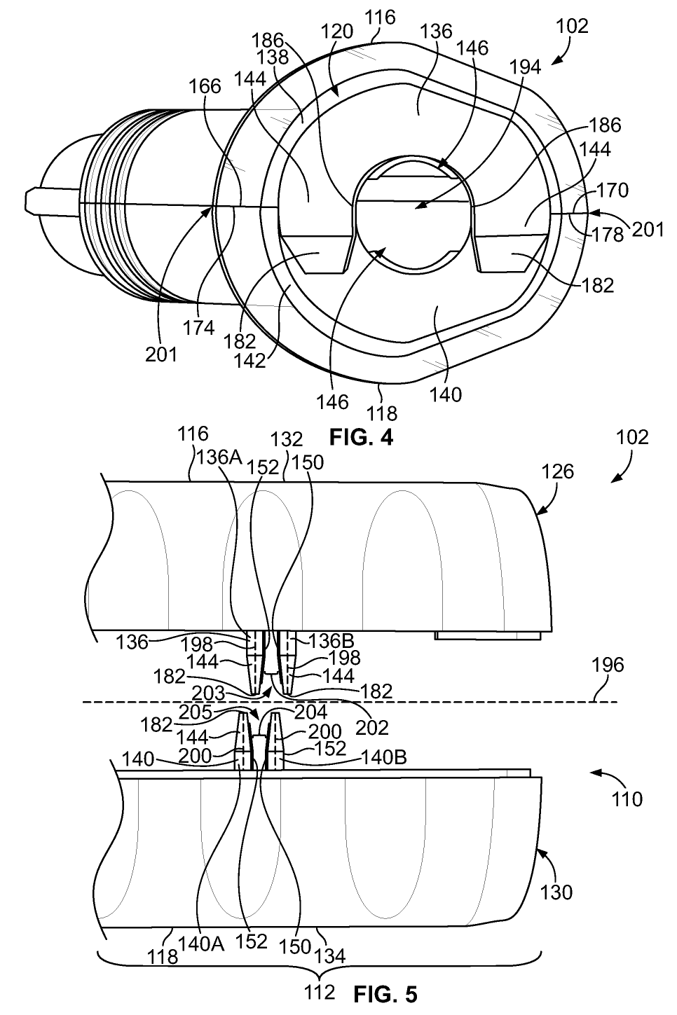

FIG. 2 is an exploded perspective view of the connector module 101 of the connector 100 shown in FIG. 1 according to an exemplary embodiment. The housing assembly 102 of the connector module 101 includes a first shell 116 and a second shell 118 that are configured to mate together to assemble the housing assembly 102. The first and second shells 116, 118 engage one another at an interface 201 (shown in FIG. 4), although the first and second shells 116, 118 are spaced apart from one another in the illustrated exploded view.

The first and second shells 116, 118 each include walls that enclose and define the interior chamber 120 (shown in FIG. 1) when the shells 116, 118 are mated. In the illustrated embodiment, the first shell 116 is disposed over the second shell 118. The first and second shells 116, 118 may be mated by moving the shells 116, 118 relatively together along a vertical axis 122. For example, the first shell 116 may be moved towards a stationary second shell 118, the second shell 118 may be moved towards a stationary first shell 116, or both shells 116, 118 may be moved towards the other shell 116, 118. Although the vertical axis 122 appears to extend in a direction parallel to gravity in FIG. 2, it is understood that the vertical axis 122 is not required to have any particular orientation with respect to gravity. As used herein, the first shell 116 may be referred to as “upper shell” 116, and the second shell 118 may be referred to as “lower shell” 118. Relative or spatial terms such as “upper,” “lower,” “left,” or “right” are only used to distinguish the referenced elements and do not necessarily require particular positions or orientations in the connector module 101 or in the surrounding environment of the connector module 101.

The upper shell 116 extends between a mating end 124 and a cable end 126. The upper shell 116 includes a cable segment 132 that extends to and includes the cable end 126. The lower shell 118 also extends between a respective mating end 128 and a cable end 130. The lower shell 118 also includes a respective cable segment 134 that extends to and includes the cable end 130. The mating and cable ends 124, 126 of the upper shell 116 align with the mating and cable ends 128, 130, respectively, of the lower shell 118 as the upper and lower shells 116, 118 are mated to form the housing assembly 102. The cable ends 126, 130 of the upper and lower shells 116, 118 combine to define the cable end 110 (shown in FIG. 1) of the housing assembly 102 when the shells 116, 118 are mated. In addition, the cable segments 132, 134 together define the cable securing region 112 (shown in FIG. 1) of the housing assembly 102.

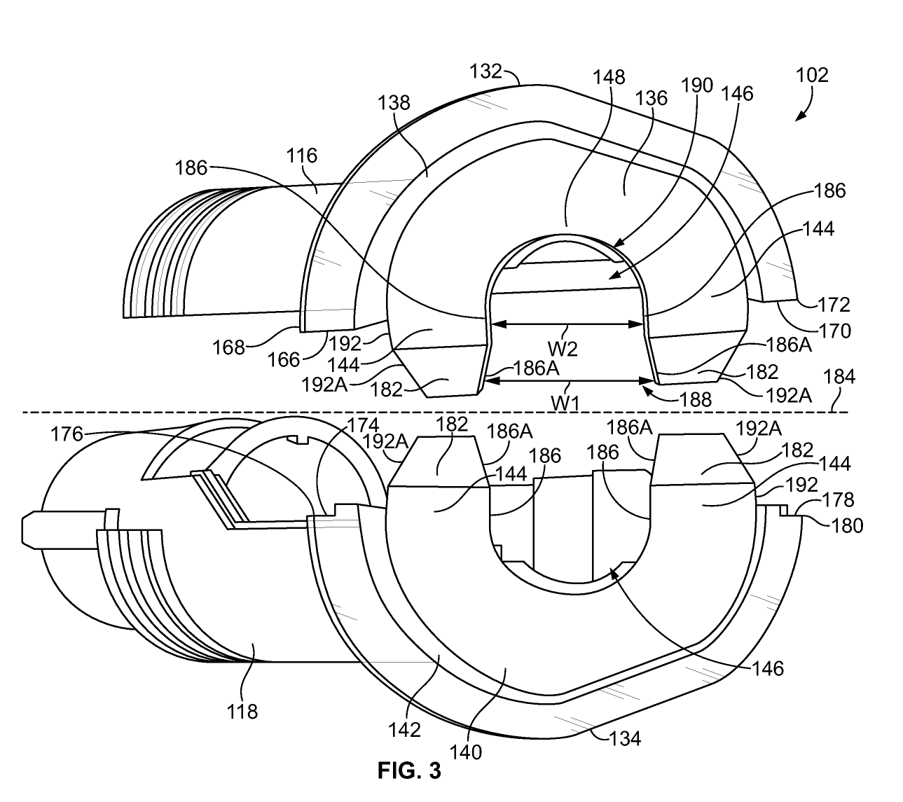

The cable segment 132 of the upper shell 116 includes at least one upper sealing rib 136 that extends into the interior chamber 120 (shown in FIG. 1) from an inner surface 138 (shown in FIG. 3) of the upper shell 116. For example, the upper sealing rib 136 in the illustrated embodiment extends downward generally along the vertical axis 122 from the inner surface 138 of the upper shell 116. The cable segment 134 of the lower shell 118 includes at least one lower sealing rib 140 that extends into the interior chamber 120 from an inner surface 142 of the lower shell 118. In the illustrated embodiment, the lower sealing rib 140 extends upward generally along the vertical axis 122 towards the upper shell 116. The upper shell 116 includes two upper sealing ribs 136 in the embodiment shown in FIG. 2, and the lower shell 118 also includes two lower sealing ribs 140. In other embodiments, however, the upper shell 116 may include only one or more than two upper sealing ribs 136, and/or the lower shell 118 may include only one or more than two lower sealing ribs 140. The number of upper sealing ribs 136 need not equal the number of lower sealing ribs 140. Each upper sealing rib 136 of the upper shell 116 is configured to engage at least one lower sealing rib 140 of the lower shell 118 as the upper and lower shells 116, 118 are mated to provide a cable seal that prevents the ingress of debris and other contaminants into the housing assembly 102 beyond the sealing ribs 136, 140.

In an embodiment, the multiple upper sealing ribs 136 each have an identical, or at least substantially similar, size and shape as one another. In addition, the multiple lower sealing ribs 140 may each have an identical, or at least substantially similar, size and shape as one another. Optionally, the upper sealing ribs 136 may have an identical, or at least substantially similar, size and shape as the size and shape of the lower sealing ribs 140. For example, the upper sealing ribs 136 and the lower sealing ribs 140 in the illustrated embodiment each have a curve U-shape. The upper and lower sealing ribs 136, 140 each include two blades 144 that are spaced apart laterally and define a slot 146 therebetween. The blades 144 may be posts that have flat broad sides. The blades 144 of each sealing rib 136, 140 may extend from a base portion 148. For example, the base portion 148 of the lower sealing rib 140 extends between the inner surface 142 of the lower shell 118 and the blades 144. The base portion 148 defines a closed end section of the slot 146 that is radially and/or laterally between the two blades 144. In the illustrated embodiment, the lower sealing ribs 140 have U-shaped curves, where the blades 144 define the end segments and the base portion 148 interconnects the blades 144, such that there is no clear demarcation between the blades 144 and the base portion 148. Such a demarcation may be more apparent in other embodiments in which the sealing ribs 140 have a different U-shaped curve. The upper sealing ribs 136 may have a similar U-shaped curve as the lower sealing ribs 140, although the base portions 148 of the upper sealing ribs 136 are not visible in FIG. 2.

In an embodiment, the slots 146 of the upper and lower sealing ribs 136, 140 are configured to receive the cable 104 therein. For example, the slots 146 may be sized and shaped to accommodate the diameter of the cable 104. The cable 104 includes multiple components that are not shown in FIG. 2. For example, the cable 104 may be an electrical cable that includes at least one conductor, an insulation layer, a cable shield, and an outer jacket 154. Only the outer jacket 154 is visible in FIG. 2. The slots 146 may be configured to receive a diameter of the cable 104 that includes the outer jacket 154, for example. But, the slots 146 may be configured to receive a reduced diameter of the cable 104, such as if the outer jacket 154 is stripped from the interior portion 107 of the cable 104 that extends into housing assembly 102 and into the slots 146 of the sealing ribs 136, 140. In an embodiment, the connector module 101 is assembled by inserting the interior portion 107 of the cable 104 into the slots 146 of the lower sealing ribs 140 and then lowering the upper shell 116 over the cable 104 along the vertical axis 122 to entrap the cable 104 therebetween, or by inserting the interior portion 107 of the cable 104 into the slots 146 of the upper sealing ribs 136 and then raising the lower shell 118 along the vertical axis 122 under the cable 104 to entrap the cable 104.

The upper sealing ribs 136 and the lower sealing ribs 140 each have a front side 150 that faces generally towards the mating end 108 (shown in FIG. 1) of the housing assembly 102 (the mating end 108 being defined by the mating ends 124, 128 of the upper and lower shells 116, 118, respectively). The upper sealing ribs 136 and the lower sealing ribs 140 each also have a rear side 152 that faces generally towards the cable end 110 (FIG. 1) of the housing assembly 102 (the cable end 110 being defined by the cable ends 126, 130 of the upper and lower shells 116, 118, respectively). It is recognized that due to curves and angles in the housing assembly 102, particularly between the sealing ribs 136, 140 and the mating end 108, the front sides 150 of the sealing ribs 136, 140 may not face directly towards the mating end 108, but rather face in a general direction that is more proximate to the mating end 108 than the cable end 110. For example, the front sides 150 of the sealing ribs 136, 140 may face in a direction that is approximately opposite to, or 180° relative to, the cable end 110, whereas the rear sides 152 may face approximately directly towards the cable end 110.

In an exemplary embodiment, as described in more detail herein, as the upper shell 116 and the lower shell 118 are mated, the front side 150 of one of the upper sealing ribs 136 abuts (e.g., mechanically engages) the rear side 152 of one of the lower sealing ribs 140 and/or the rear side 152 of the one upper sealing rib 136 abuts the front side 150 of the one lower sealing rib 140. The engagement between the upper sealing rib 136 and the lower sealing rib 140 seals the interior chamber 120 (shown in FIG. 1). For example, the upper sealing rib 136 and the lower sealing rib 140 combine to fill the space between the cable 104 and the inner surfaces 138 (shown in FIG. 3), 142 of the upper and lower shells 116, 118.

In an embodiment, the upper shell 116 and the lower shell 118 are composed of at least one dielectric material, such as one or more plastics or other polymers. The upper shell 116 and/or the lower shell 118 may be composed entirely of the dielectric material(s) or may include a conductive material, such as one or more metals, that is overmolded in the dielectric material(s). Alternatively, the upper shell 116 and/or the lower shell 118 may be formed entirely of a conductive material, such as one or more metals. The upper shell 116 and the lower shell 118 may be fabricated using a molding process. In an exemplary embodiment, the upper sealing ribs 136 are formed integral with the upper shell 116, such that the upper sealing ribs 136 are formed as the upper shell 116 is formed. Similarly, the lower sealing ribs 140 are formed integral with the lower shell 118 in an exemplary embodiment. By forming the upper and lower sealing ribs 136, 140 integrally with the respective shells 116, 118 no additional assembly steps are required to add sealing components (such as rubber bushings or gaskets). In addition, integral sealing ribs 136, 140 are unitary with the respective inner surfaces 138 (shown in FIG. 3), 142 from which the ribs 136, 140 extend, so there is no risk of leak paths forming between the ribs 136, 140 and the respective inner surfaces 138, 142. In an alternative embodiment, at least one of the upper sealing ribs 136 or the lower sealing ribs 140 are discrete components that are attached to the corresponding shell 116, 118 via a welding process, for example.

In addition to the sealing ribs 136, 140, the housing assembly 102 may include a clamp 156 that secures the cable 104 within the interior chamber 120 and a strain relief guide 158 that guides the cable 104 out of the cable opening 109 (shown in FIG. 1) at the cable end 110 (FIG. 1). The clamp 156 is formed by multiple clamp ribs 160. The lower shell 118 includes two clamp ribs 160 in the illustrated embodiment, and the upper shell 116, although not visible, includes at least one clamp rib 160. The clamp ribs 160 are configured to engage and compress the cable 104 as the upper and lower shells 116, 118 are mated, which secures the cable 104 via an interference fit. The strain relief guide 158 is defined by an upper strain relief funnel 162 at the cable end 126 of the upper shell 116 and a lower strain relief funnel 164 at the cable end 130 of the lower shell 118. The upper and lower strain relief funnels 162, 164 define the cable opening 109 through which the cable 104 enters the housing assembly 102. The strain relief guide 158 is configured to support the portion of the cable 104 that aligns with the cable end 110 of the housing assembly 102, reducing forces on the cable 104 that may damage the cable 104. In an exemplary embodiment, the clamp ribs 160 and the strain relief funnels 162, 164 are formed integral with the respective upper and lower shells 116, 118, and are therefore not discrete components that are assembled to the shells 116, 118 after fabrication.

FIG. 3 is a sectional exploded view of the housing assembly 102 according to an embodiment. The section view shows one upper sealing rib 136 of the upper shell 116 and one lower sealing rib 140 of the lower shell 118. The cable segment 132 of the upper shell 116 includes a left side wall 166 at or proximate to a left edge 168 of the cable segment 132 and a right side wall 170 at or proximate to a right edge 172. Similarly, the cable segment 134 of the lower shell 118 includes a left side wall 174 at or proximate to a left edge 176 of the cable segment 134 and a right side wall 178 at or proximate to a right edge 180. As the upper and lower shells 116, 118 are mated, the left side wall 174 of the lower shell 118 is configured to engage the left side wall 166 of the upper shell 116, and the right side wall 178 of the lower shell 118 is configured to engage the right side wall 170 of the upper shell 116. The engagement between the left side walls 166, 174 defines a portion of the interface 201 (shown in FIG. 4), and the engagement between the right side walls 170, 178 defines another portion of the interface 201.

The inner surface 138 of the upper shell 116 extends laterally between the left side wall 166 and the right side wall 170 of the upper shell 116. Similarly, the inner surface 142 of the lower shell 118 extends laterally between the respective left side wall 174 and the right side wall 178. The inner surfaces 138, 142 may be curved and/or arc-shaped. In an alternative embodiment, at least one of the inner surface 138 of the upper shell 116 along the cable segment 132 or the inner surface 142 of the lower shell 118 along the cable segment 134 has other than an arc-shape, such as a V-shape, a box-shape, or the like.

The blades 144 of the upper sealing rib 136 project downward beyond a lateral plane defined by the left and right side walls 166, 170 of the upper shell 116. The blades 144 of the lower sealing rib 140 project upward beyond a lateral plane defined by the left and right side walls 174, 178 of the lower shell 118. Thus, as the upper and lower shells 116, 118 are mated, the distal ends 182 of the blades 144 of the upper sealing rib 136 overlap and extend past distal ends 182 of the blades 144 of the lower sealing rib 140.

The slot 146 of the upper sealing rib 136 has a lateral width that extends parallel to a lateral axis 184. The lateral width is defined between interior edges 186 of the blades 144. The lateral width may not be constant along a height of the slot 146 between an open end 188 and a closed end 190 defined by the base portion 148. For example, the distal end 182 of each of the blades 144 of the upper sealing rib 136 (and any other upper sealing ribs 136 of the upper shell 116) may be beveled along the interior edge 186. As a result, the slot 146 of the upper sealing rib 136 may have a first width W1 between the beveled distal ends 182 that is wider than a second width W2 of the slot 146 between portions of the blades 144 more proximate to the inner surface 138 and/or the base portion 148. The resulting interior beveled sections 186A of the interior edges 186 of the blades 144 provide a cable lead-in section that guides the cable 104 (shown in FIG. 2) into alignment with the narrower region of the slot 146 during assembly. Optionally, the lower sealing rib 140 shown in FIG. 3 may also have interior beveled sections 186A of corresponding interior edges 186 similar to the upper sealing rib 136 in order to provide a cable lead-in section. In an alternative embodiment, only one or neither of the upper and lower sealing ribs 136, 140 include such interior beveled sections 186A that provide a cable lead-in section.

In an embodiment, exterior edges 192 of the blades 144 of the upper sealing rib 136 and/or the lower sealing rib 140 are also beveled at the distal ends 182. The resulting exterior beveled sections 192A are configured to provide clearance such that the distal ends 182 of the blades 144 do not engage and catch upon the other cable segment 132, 134 during mating. For example, the exterior beveled sections 192A of the blades 144 of the upper sealing rib 136 provide clearance for accommodating the curved inner surface 142 of the lower shell 118 during mating, and the exterior beveled sections 192A of the blades 144 of the lower sealing rib 140 provide clearance for accommodating the curved inner surface 138 of the upper shell 116.

FIG. 4 is a sectional assembled view of the housing assembly 102 according to an embodiment. As the upper and lower shells 116, 118 are mated, the distal ends 182 of the blades 144 of the upper sealing rib 136 overlap and extend past the distal ends 182 of the blades 144 of the lower sealing rib 140 (and vice-versa). The slots 146 of the upper and lower sealing ribs 136, 140 together define a closed cable channel 194. The cable channel 194 is configured to receive the cable 104 (shown in FIG. 2) therein such that the cable 104 extends through the cable channel 194 and the upper and lower sealing ribs 136, 140 surround the entire perimeter of the cable 104. In an exemplary embodiment, the slots 146 of the upper and lower sealing ribs 136, 140 are sized and shaped such that the cable channel 194 has a diameter that is equal to or less than a diameter of the cable 104 such that no clearance exists between the cable 104 and a perimeter of the cable channel 194. Thus, the cable 104 may be at least slightly compressed within the cable channel 194 such that no lead paths may form between the cable 104 and the interior edges 186 of the sealing ribs 136, 140 that define the cable channel 194. It is recognized that the cable 104 may not have a circular cross-section. Although the term “diameter” is used above, the term is used in a broader sense to describe a size (e.g., cross-sectional area) of the cable 104 and of the cable channel 194. The cable channel 194 is not limited to having a circular shape. For example, the cable channel 194 may have an elliptical shape, a rectangular shape with rounded edges, or the like.

The upper shell 116 engages the lower shell 118 at an interface 201. The interface 201 is partially defined between the left side wall 166 of the upper shell 116 and the left side wall 174 of the lower shell 118. Another portion of the interface 201 is defined between the right side walls 170, 178 of the upper and lower shells 116, 118, respectively.

When the upper and lower shells 116, 118 are mated, the upper and lower sealing ribs 136, 140 extend into the interior chamber 120. As shown in FIG. 4, the combination of the upper and lower sealing ribs 136, 140 extend around a full perimeter of the interior chamber 120. For example, the upper sealing rib 136 extends along the full inner perimeter of the inner surface 138 of the upper shell 116, and the lower sealing rib 140 extends along the full inner perimeter of the inner surface 142 of the lower shell 118. As such, no leak paths exist radially outward of the sealing ribs 136, 140 between the sealing ribs 136, 140 and the inner surfaces 138, 142. The only opening in the interior chamber 120 through the upper and lower sealing ribs 136, 140 is the cable channel 194, which, as described, seals to the perimeter of the cable 104 (shown in FIG. 2). Thus, the upper and lower sealing ribs 136, 140 provide an ingress protection seal that blocks debris and other contaminants from propagating through the sealing ribs 136, 140 further into the interior region 120.

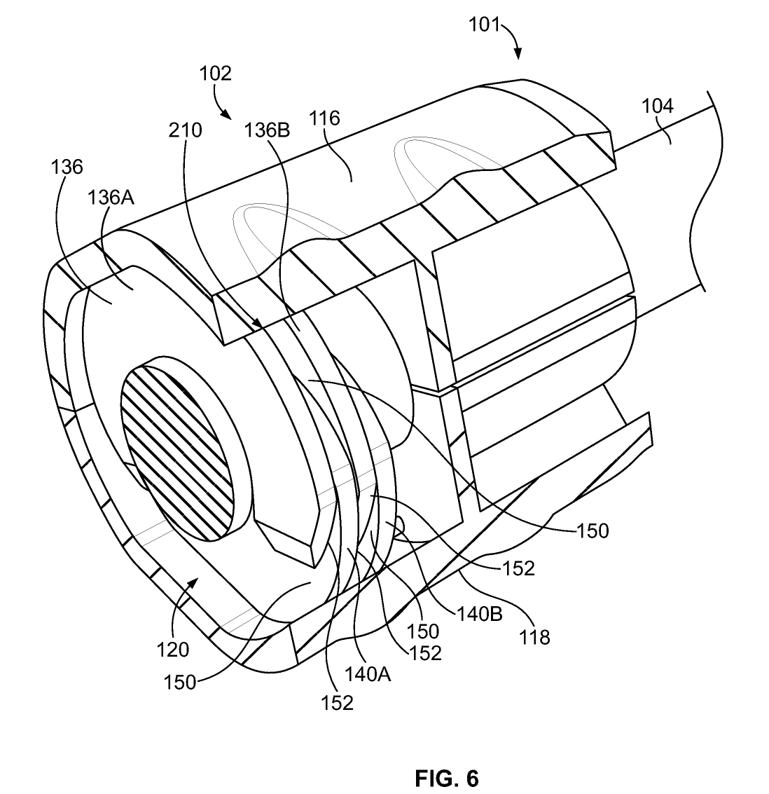

FIG. 5 is an exploded side view of a portion of the housing assembly 102 according to an embodiment. The portion of the housing assembly 102 is a portion of the cable securing region 112 that includes the cable end 110 defined by the cable ends 126, 130 of the upper and lower shells 116, 118, respectively. The cable securing region 112 (for example, the cable segments 132, 134 of the upper and lower shells 116, 118) extends along a longitudinal axis 196. In an exemplary embodiment, each upper sealing rib 136 is offset from each lower sealing rib 140 along the longitudinal axis 196. For example, the upper sealing ribs 136 are offset from the lower sealing ribs 140, such that an axial center 198 of each upper sealing rib 136 does not align with an axial center 200 of each lower sealing rib 140. Since the upper sealing ribs 136 are offset from the lower sealing ribs 140, upon mating the upper and lower shells 116, 118 the upper and lower sealing ribs 140 engage one another but do not stub or catch on one another, which allows the mating to occur without undue interference.

In the illustrated embodiment, the upper shell 116 includes a first upper sealing rib 136A and a second upper sealing rib 136B that is spaced apart axially from the first upper sealing rib 136A along the longitudinal axis 196. The second upper sealing rib 136B is located rearward of the first upper sealing rib 136A, meaning that the second upper sealing rib 136B is disposed between the first upper sealing rib 136A and the cable end 126 of the upper shell 116. In addition, the lower shell 118 includes first and second lower sealing ribs 140A, 140B that are spaced apart. The second lower sealing rib 140B is rearward of the first lower sealing rib 140A, such that it is located between the first sealing rib 140A and the cable end 130 of the lower shell 118.

The first and second upper sealing ribs 136A, 136B define a gap 202 therebetween. The gap 202 has an axial length that extends along the longitudinal axis between the rear side 152 of the first upper sealing rib 136A and the front side 150 of the second upper sealing rib 136B. The gap 202 is configured to receive one of the lower sealing ribs 140 therein as the upper and lower shells 116, 118 are mated. For example, as shown in FIG. 5, the gap 202 is aligned with and configured to receive the second lower sealing rib 140B. In an embodiment, the axial length of the gap 202 is equal to or less than a thickness of the lower sealing rib 140B. The thickness of the lower sealing rib 140B is a thickness along the longitudinal axis 196. Since the gap 202 is equal to or less than the thickness of the lower sealing rib 140B, the lower sealing rib 140B engages both the upper sealing ribs 136A, 136B as the sealing rib 140B is received in the gap 202. For example, the front side 150 of the lower sealing rib 140B abuts the rear side 152 of the first upper sealing rib 136A, and the rear side 152 of the lower sealing rib 140B abuts the front side 150 of the second upper sealing rib 136B. As the shells 116, 118 are moved towards one another, the front side 150 of the lower sealing rib 140B engages and slides against the rear side 152 of the first upper sealing rib 136A, and the rear side 152 of the sealing rib 140B slides against the front side 150 of the second upper sealing rib 136B. The interference caused by the lower sealing rib 140B may force the first and second upper sealing ribs 136A, 136B to deflect at least partially in opposite directions. The first and second upper sealing ribs 136A, 136B may provide a biasing force on the lower sealing rib 140B which supports the integrity of the seal that is formed by the interlocking sealing ribs 136A, 140B, 136B.

In an embodiment, the distal ends 182 of the blades 144 of the upper sealing ribs 136A, 136B are tapered. For example, the thickness of the corresponding sealing ribs 136A, 136B along the longitudinal axis 196 may be reduced at the distal end 182 relative to a more proximal location in order to provide a lead-in region 203 for guiding the lower sealing rib 140B into the gap 202 without stubbing or catching. The tapering of the distal ends 182 allows the lead-in region 203 to have a greater axial length than the gap 202.

In the illustrated embodiment, the first and second lower sealing ribs 140A, 140B define a gap 204 therebetween along the longitudinal axis 196 that is configured to receive one of the upper sealing ribs 136 therein. More specifically, the first upper sealing rib 136A aligns with and is received in the gap 204. Like the description of the gap 202 above, the gap 204 may have an axial length that is equal to or less than a thickness of the upper sealing rib 136A such that the front side 150 of the upper sealing rib 136A engages and abuts the rear side 152 of the first lower sealing rib 140A and the rear side 152 of the upper sealing rib 136A engages and abuts the front side 150 of the second lower sealing rib 140B. The interaction between the first upper sealing rib 136A and the lower sealing ribs 140A, 140B provides an interference fit. For example, deflection of the lower sealing ribs 140A, 140B in opposite directions by the upper sealing rib 136A causes the first and second lower sealing ribs 140A, 140B to exert an opposite biasing force on the upper sealing rib 136A, which supports the integrity of the seal that is formed by the interlocking sealing ribs 140A, 136A, 140B. The lower sealing ribs 140A, 140B may also be tapered at the distal ends 182 to provide a lead-in region 205 to prohibit stubbing.

Although two upper sealing ribs 136A, 136B and two lower sealing ribs 140A, 140B are shown in FIG. 5, it is recognized that other embodiments may include other numbers of sealing ribs 136 and/or 140. For example, in one embodiment, the upper shell 116 includes one upper sealing rib 136 and the lower shell 118 includes one lower sealing rib 140. The upper sealing rib 136 engages and slides against the lower sealing rib 140 upon mating the shells 116, 118 to provide the seal. In another embodiment, the upper shell 116 includes two sealing ribs 136A, 136B, while the lower shell 118 only includes the sealing rib 140B that is received in the gap 202. In still other embodiments, the upper shell 116 and/or the lower shell 118 may include more than two respective sealing ribs 136, 140.

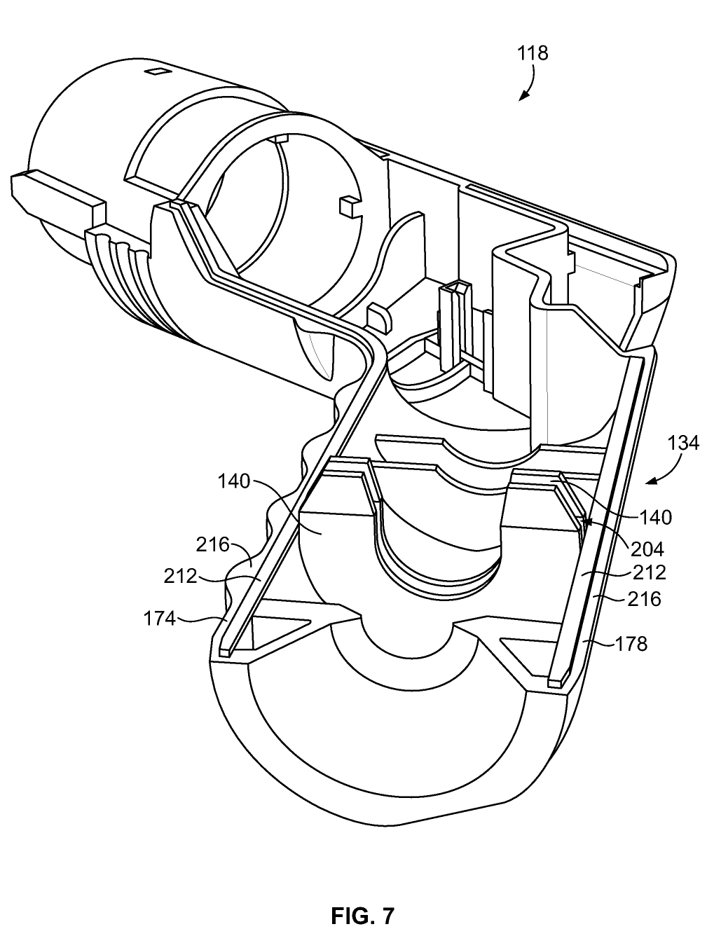

FIG. 6 is a perspective cross-sectional view of the connector module 101 according to an embodiment, showing the cable 104 in an assembled housing assembly 102. The upper shell 116 and the lower shell 118 are mated. The upper sealing ribs 136 of the upper shell 116 are interlocked with the lower sealing ribs 140 of the lower shell 118 to seal the interior chamber 120. For example, the rear side 152 of the first upper sealing rib 136A abuts the front side 150 of the first lower sealing rib 140A. The rear side 152 of the first lower sealing rib 140A abuts the front side 150 of the second upper sealing rib 136B. And, the rear side 152 of the second upper sealing rib 136B abuts the front side 150 of the second lower sealing rib 140B.

In the illustrated embodiment, the first upper sealing rib 136A and the second lower sealing rib 140B are located at outer ends of an interlocking stack 210 formed by the sealing ribs 136, 140. The first lower sealing rib 140A and the second upper sealing rib 136B are interior of and between the ribs 136A and 140B along the longitudinal axis 196 (shown in FIG. 5). The first upper sealing rib 136A and the second lower sealing rib 140B are referred to as outer ribs, while the first lower sealing rib 140A and the second upper sealing rib 136B are referred to as inner ribs that are axially between the outer ribs. The outer ribs may press the inner ribs against one another, which supports the seal formed by the interlocking stack 210. For example, the primary sealing interface may be between the two inner ribs due to the forces applied on the inner ribs by the outer ribs. The sealing interface between the first lower sealing rib 140A and the second upper sealing rib 136B shown in FIG. 6 may be impermeable to water and other liquids, to dust and other debris, and to other contaminants.

FIG. 7 is a perspective view of the lower shell 118 according to an embodiment. The left and right side walls 174, 178 in an embodiment include or define corresponding beads 212. The beads 212 each extend a length of the cable segment 134. The beads 212 may be formed of a moldable dielectric material, such as a thermoplastic. The beads 212 are configured to aid in joining the lower shell 118 to the upper shell 116 (shown in FIG. 2) during the assembly process. For example, the beads 212 may at least partially melt when heated. The at least partially melted beads 212 may fill the interface 201 between the upper and lower shells 116, 118. As the melted material in the interface 201 cools, the interface 201 is sealed.

As shown in FIG. 7, the beads 212 are located laterally proximate to the inner surface 142 of the lower shell 118. Thus, as the beads 212 melt and are compressed between the shells 116, 118, some of the material flows radially inward towards the lower sealing ribs 140. Some of the flowing material enters the gap 204 between the two lower sealing ribs 140, which supports the seal provided by the interlocking sealing ribs described above. The left and right side walls 174, 178 may include ledges 216 located laterally outward of the beads 212. The ledges 216 are configured to provide a surface that retains the flowing material of the beads 212, prohibiting the material from flowing along an outer perimeter of the lower shell 118. Optionally, the upper shell 116 may include beads instead of, or in addition to, the beads 212 of the lower shell 118.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

What is claimed is:

1. A connector module comprising:
a housing assembly defined by an upper shell and a lower shell that mate at an interface and define an interior chamber therebetween, the upper shell and the lower shell each including a respective cable segment that together define a cable securing region extending along a longitudinal axis, the cable segment of the upper shell including an upper sealing rib extending into the interior chamber from an inner surface of the upper shell, the cable segment of the lower shell including a lower sealing rib extending into the interior chamber from an inner surface of the lower shell, the upper sealing rib and the lower sealing rib each including two blades and a slot defined between the two blades, the slots of the upper sealing rib and the lower sealing rib configured to receive a common cable therein,
wherein, when the upper shell and the lower shell are mated, a front side of the upper sealing rib abuts a rear side of the lower sealing rib to seal the interior chamber around the cable in the slots of the upper and lower sealing ribs.

2. The connector module of claim 1, wherein the upper sealing rib of the upper shell is offset from the lower sealing rib of the lower shell along the longitudinal axis such that an axial center of the upper sealing rib does not align with an axial center of the lower sealing rib.

3. The connector module of claim 1, wherein a distal end of each of the blades of the upper sealing rib is tapered such that a thickness of the corresponding blade along the longitudinal axis is reduced at the distal end to provide a lead-in region that accommodates the lower sealing rib.

4. The connector module of claim 1, wherein the slots of the upper and lower sealing ribs define a closed cable channel when the upper shell and the lower shell are mated, the cable configured to extend through the cable channel, the cable channel having a diameter equal to or less than a diameter of the cable such that no clearance exists between the cable and a perimeter of the cable channel.

5. The connector module of claim 1, wherein the upper shell and the lower shell are moved towards one another along a vertical axis during mating, the front side of the upper sealing rib engaging and sliding against the rear side of the lower sealing rib as the upper and lower shells are moved during mating.

6. The connector module of claim 1, wherein the blades of the upper sealing rib extend from a base portion of the upper sealing rib that is between the inner surface of the upper shell and the blades of the upper sealing rib, the base portion defining a closed end section of the slot of the upper sealing rib such that the slot is spaced apart from the inner surface of the upper shell.

7. The connector module of claim 6, wherein a distal end of each of the blades of the upper sealing rib is beveled such that the slot of the upper sealing rib is wider in a lateral direction between the distal ends of the blades than between portions of the blades that are more proximate to the base portion of the upper sealing rib to provide a cable lead-in section.

8. The connector module of claim 1, wherein the lower sealing rib of the lower shell is a first lower sealing rib and the lower shell further includes a second lower sealing rib spaced apart from the first lower sealing rib along the longitudinal axis and defining a lower gap therebetween, the lower gap receiving the upper sealing rib therein when the upper and lower shells are mated, the lower gap having an axial length along the longitudinal axis that is no greater than a thickness of the upper sealing rib along the longitudinal axis such that the front side of the upper sealing rib abuts the rear side of the first lower sealing rib and the rear side of the upper sealing rib abuts the front side of the second lower sealing rib.

9. The connector module of claim 1, wherein the upper sealing rib of the upper shell is a first upper sealing rib and the upper shell further includes a second upper sealing rib spaced apart from the first upper sealing rib along the longitudinal axis and defining an upper gap therebetween, the upper gap receiving the lower sealing rib of the lower shell therein when the upper and lower shells are mated, the upper gap having an axial length along the longitudinal axis that is no greater than a thickness of the lower sealing rib along the longitudinal axis such that the front side of the lower sealing rib abuts the rear side of the first upper sealing rib and the rear side of the lower sealing rib abuts the front side of the second upper sealing rib.

10. The connector module of claim 9, wherein the lower sealing rib of the lower shell that is received in the upper gap between the first and second upper sealing ribs is a first lower sealing rib, the lower shell further including a second lower sealing rib spaced apart from the first lower sealing rib along the longitudinal axis and defining a lower gap therebetween that receives the second upper sealing rib therein, the lower gap between the first and second lower sealing ribs having an axial length along the longitudinal axis that is no greater than a thickness of the second upper sealing rib along the longitudinal axis such that the front side of the second upper sealing rib abuts the rear side of the first lower sealing rib and the rear side of the second upper sealing rib abuts the front side of the second lower sealing rib.

11. The connector module of claim 10, wherein the first upper sealing rib and the second lower sealing rib define outer ribs, the first lower sealing rib and the second upper sealing rib defining inner ribs that are disposed axially between the outer ribs along the longitudinal axis, the outer ribs pressing the inner ribs against one another.

12. The connector module of claim 1, wherein the cable segment of the upper shell includes a left side wall and a right side wall, the blades of the upper sealing member projecting from the inner surface of the upper shell generally vertically beyond the left and right side walls such that distal ends of the blades of the upper sealing member overlap distal ends of the blades of the lower sealing member during mating of the upper and lower shells.

13. The connector module of claim 1, wherein the cable segment of the upper shell includes a left side wall and a right side wall, the cable segment of the lower shell including a left side wall that engages the left side wall of the upper shell at the interface and a right side wall that engages the right side wall of the upper shell at the interface, the left and right side walls of the cable segment of at least one of the upper shell or the lower shell defining corresponding beads that extend a length of the respective cable segment, the beads being formed of a moldable thermoplastic and configured to at least partially melt when heated to seal the interface between the upper shell and the lower shell.

14. The connector module of claim 1, wherein the upper sealing rib is formed integral to the upper shell and the lower sealing rib is formed integral to the lower shell.

15. A connector module comprising:
a housing assembly defined by an upper shell and a lower shell that mate at an interface and define an interior chamber therebetween, the upper shell and the lower shell each including a respective cable segment that together define a cable securing region extending along a longitudinal axis, the cable segment of the upper shell including at least first and second upper sealing ribs extending into the interior chamber from an inner surface of the upper shell, the second upper sealing rib being spaced apart from the first upper sealing rib along the longitudinal axis and defining an upper gap therebetween, the cable segment of the lower shell including at least a first lower sealing rib extending into the interior chamber from an inner surface of the lower shell, the first and second upper sealing ribs and the first lower sealing rib each including two blades and a slot defined between the two blades that is configured to receive a cable therein,
wherein, when the upper shell and the lower shell are mated, the first lower sealing rib is received in the upper gap, the upper gap having an axial length along the longitudinal axis that is no greater than a thickness of the first lower sealing rib along the longitudinal axis such that a front side of the first lower sealing rib abuts a rear side of the first upper sealing rib and a rear side of the first lower sealing rib abuts a front side of the second upper sealing rib to seal the interior chamber around the cable in the slots of the upper and lower sealing ribs.

16. The connector module of claim 15, wherein distal ends of the blades of the first and second upper sealing ribs are tapered along the longitudinal axis such that the axial length of the upper gap between the first and second upper sealing ribs is greater at the distal ends of the blades than portions of the blades more proximate to the inner surface of the upper shell to provide a lead-in region that accommodates the first lower sealing rib.

17. The connector module of claim 15, wherein the axial length of the upper gap is less than a thickness of the first lower sealing rib along the longitudinal axis such that the first lower sealing rib deflects the first and second upper sealing ribs in opposite directions along the longitudinal axis when the upper and lower shells are mated.

18. The connector module of claim 15, wherein the lower shell further includes a second lower sealing rib spaced apart from the first lower sealing rib along the longitudinal axis and defining a lower gap therebetween, the lower gap receiving the first upper sealing rib when the upper and lower shells are mated, the lower gap having an axial length along the longitudinal axis that is no greater than a thickness of the first upper sealing rib along the longitudinal axis such that a rear side of the first upper sealing rib abuts the front side of the first lower sealing rib and a front side of the first upper sealing rib abuts a rear side of the second lower sealing rib.

19. The connector module of claim 15, wherein the first and second upper sealing ribs and the first and second lower sealing ribs define an interlocking stack when the upper and lower shells are mated, the first upper sealing rib and the first lower sealing rib defining inner ribs of the interlocking stack that are disposed axially along the longitudinal axis between outer ribs defined by the second upper sealing rib and the second lower sealing rib, the outer ribs pressing the inner ribs against each other.

20. The connector module of claim 15, wherein each of the first and second upper sealing ribs include a respective base portion between the inner surface of the upper shall and the respective blades, the base portions defining closed end sections of the respective slots of the first and second upper sealing ribs such that the slots are spaced apart from the inner surface of the upper shell.
